(19) United States
(12) Patent Application Publication
(10) Pub. No.: US 2011/0022480 A1
(43) Pub. Date: Jan. 27, 2011

(54) Loss Prevention At Point Of Sale

(75) Inventors: Robert S. Hoblit, Raleigh, NC (US); Thomas J. Prorock, Raleigh, NC (US); Karen Waluk, Raleigh, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 12/508,333

(22) Filed: Jul. 23, 2009

(51) Int. Cl. G06Q 20/00

(52) U.S. Cl. 705/16

(57) ABSTRACT

Loss prevention at a point of sale (‘POS’) with POS apparatus including a microphone, a speech to text converter, a POS transaction module, a POS transaction log, and a POS security module, also including storing, by the POS transaction module in the transaction log for commercial transactions at the POS, information describing each transaction, including capturing for each transaction, into the transaction log through the microphone and the speech to text converter as text, speech utterances of transaction participants; identifying by the POS security module a risk of loss in dependence upon the information stored in the transaction log including the captured speech utterances; and notifying by the POS security module the store manager of the identified risk of loss.

### BACKGROUND OF THE INVENTION

1. Field of the Invention

The field of the invention is data processing, or, more specifically, methods, apparatus, and products for loss prevention at a point of sale.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the areas of technology that has seen substantial improvement over the years is automation of commercial transaction at the ‘point of sale’ or ‘point of service’ (‘POS’). In retail systems there are two major components to the overall POS solution. The first is the actual POS system itself and the other is the transaction log. The POS system is the “engine” which provides the capability to complete all aspects of both sale and non-sale transactions. Correspondingly, the transaction log is a complex archive of the details of every transaction that occurs on the POS system. Loss, sometimes referred to as shrinkage, is a widespread problem in the retail industry. Significant measures are put in place to control the amount of shrinkage, and there are various loss prevention tools that help retailers detect and prevent fraud. Major retailers have loss prevention organizations to address this common problem. The need continues, however, for enhancement of loss prevention measures at the point of sale or service.

### SUMMARY OF THE INVENTION

Methods, apparatus, and computer program products for loss prevention at a point of sale (‘POS’), the POS located in a store having a store manager, with POS apparatus including a microphone, a speech to text converter, a POS transaction module that is a module of automated computing machinery configured to effect commercial transactions at the POS, a POS transaction log, and a POS security module that is a module of automated computing machinery configured to analyze contents of the POS transaction log to identify risks of loss, also including storing, by the POS transaction module in the transaction log for commercial transactions at the POS, information describing each transaction, including capturing for each transaction, into the transaction log through the microphone and the speech to text converter as text, speech utterances of transaction participants; identifying by the POS security module a risk of loss in dependence upon the information stored in the transaction log including the captured speech utterances; and notifying by the POS security module the store manager of the identified risk of loss.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a line drawing and functional block diagram of apparatus for loss prevention at a point of sale according to embodiments of the present invention.

FIG. 2 sets forth a flow chart illustrating an example method of loss prevention at a point of sale according to embodiments of the present invention.

FIG. 3 sets forth a flow chart illustrating a further example method of loss prevention at a point of sale according to embodiments of the present invention.

### DETAILED DESCRIPTION OF EXAMPLE EMBODIMENTS

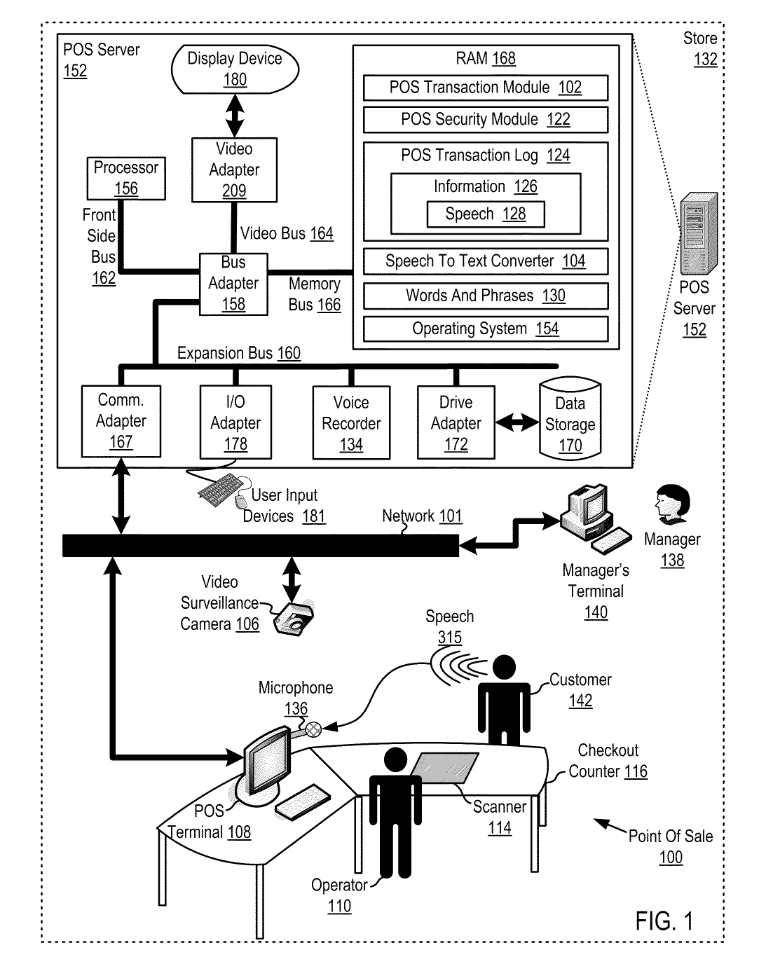

Exemplary methods, apparatus, and products for loss prevention at a point of sale in accordance with the present invention are described with reference to the accompanying drawings, beginning with FIG. 1. FIG. 1 sets forth a line drawing and functional block diagram of apparatus for loss prevention at a point of sale according to embodiments of the present invention. The apparatus of FIG. 1 represents a loss prevention security system that carries out loss prevention at a point of sale according to embodiments of the present invention. The apparatus of FIG. 1 is disposed within a store (132) having a store manager (138). The apparatus of FIG. 1 includes at the actual point of sale (100) a checkout counter (116), a bar code scanner (114), a video surveillance camera (106), a POS terminal (108), and a microphone (136).

The apparatus at the actual point of sale (100), the bar code scanner (114), the video surveillance camera (106), the POS terminal (108), and the microphone (136), is coupled for data communications through network (101) to a POS server (152). The POS server (152) is automated computing machinery, useful for loss prevention at a point of sale according to embodiments of the present invention, that provides by request-response messaging and other means as will occur to those of skill in the art substantive automation for transactions at the point of sale (100). The POS server (152) of FIG. 1 includes at least one computer processor (156) or ‘CPU’ as well as random access memory (168) (‘RAM’) which is connected through a high speed memory bus (166) and bus adapter (158) to processor (156) and to other components of the POS server (152).

The POS server in this example includes a POS transaction module (102), which is a module of automated computing machinery configured to effect commercial transactions at the POS (100). The POS server is shown in this example as a module of computer program instructions disposed in RAM. Such a configuration is not a limitation of the present invention, however, because a module such as the POS transaction module can also be implemented as an application specific integrated circuit (‘ASIC’), a complex programmable logic device (‘CPLD’), a field programmable gate array (‘FPGA’), and in other forms of hardware or combinations of hardware and software as may occur to those of skill in the art.

The POS server (152) in this example also includes a speech to text converter (104), a module of automated computing machinery that is coupled to the microphone (136) through network (101) and communications adapter (167). The speech to text converter is configured to accept speech utterances as Voice Over Internet Protocol (‘VoIP’) message traffic, convert the utterances into text, and store the text as part of the information describing POS transactions in the POS transaction log. The speech to text converter (104) is another example of a module of automated computing machinery which, like most such modules in this example, can be implemented as computer program instructions to be executed on a processor, an ASIC, a CPLD, an FPGA, and in other ways as will occur to those of skill in the art.

The POS server (152) in the example of FIG. 1 includes a POS transaction log which implements the storage of information describing transactions that occur at the point of sale (100). An example of a transaction log that can be improved for loss prevention at a point of sale according to embodiments of the present invention is a ‘TLOG,’ a POS transaction log implemented according to the POSlog standard of the International XML Retail Cooperative (‘IXRetail’). Examples of information stored in the POS transaction log include the date and time of each transaction, a transaction type for each transaction (sale, return, cash, credit, and so on), descriptions of goods sold or returned, descriptions of services provided to customers, amounts of goods involved in each transaction (sold or returned), and prices of goods sold or returned. The POS server in this example also includes a POS security module (122), which is a module of automated computing machinery configured to analyze contents of the POS transaction log (124) to identify risks of loss—which can include, for example, risks of loss by fraud and risks of loss by theft.

The apparatus in the example of FIG. 1 operates generally to implement loss prevention at a point of sale as follows: The POS transaction module (102) stores in the transaction log (124) for commercial transactions at the POS (100) information (126) describing each transaction, including capturing for each transaction, into the transaction log through the microphone (136) and the speech to text converter (104) as text, speech utterances (315, 128) of transaction participants. Transaction participants here are shown as a customer (142) and an operator (110), but transaction participants can also include supervisors, security consultants, sales clerks, managers, and others as will occur to those of skill in the art. In this example, for convenience of illustration, only the customer (142) is shown to express speech (315) for capture through the microphone (136) and the text to speech converter (104) as captured speech (128) to be associated with a transaction in the transaction log (124). Readers will understand, however, that according to embodiments of the present invention speech from all participants in a transaction can be, and in embodiments typically is, so captured.

Having the captured speech utterances in the form of text (128), the POS security module (122) identifies a risk of loss in dependence upon the information stored in the transaction log including the captured speech utterances. The POS security module can carry out this identification of a risk of loss, for example, by comparing previously stored words and phrases (130) indicative of risk of loss with captured speech utterances (128). This comparison can be in effect a text string comparison when the speech utterances have been converted from audio to text and stored as text and the words and phrases indicative of risk of loss are also stored in the form of text. When the POS security module (122) identifies a risk of loss, the POS security module notifies the store manager of the identified risk of loss. Such notification can be carried out, for example, by email to the manager's computer terminal (140), by text message to the manager's cell phone, by instant messaging to the manager's terminal, and in other ways as will occur to those of skill in the art.

The POS server in this example includes a voice recorder (134), a module of automated computing machinery that accepts speech utterances (315) in the form of encoded audio and stores the audio as part of the information (126) describing each transaction. The POS transaction module (122) operates the voice recorder (134) to store the information (126) describing each transaction so as to include for each transaction into the transaction log through the microphone (136) and the voice recorder (134) as audio, captured speech utterances of transaction participants. In this way, speech stored with each transaction in the transaction log can be in both forms, audio as well as text. Having audio versions of speech utterances for transactions, the POS security module can identify a risk of loss by searching the stored information describing each transaction for captured audio speech utterances of a particular transaction participant. With this quantity and quality of information describing each transaction, the POS security module can identify risks of loss by analyzing the information stored in the transaction log across many transactions. Such analysis across many transactions can be carried out, for example, by data mining the information stored in the transaction log for patterns of risk of loss.

Also disposed in RAM (168) in the example of FIG. 1 is an operating system (154). Operating systems useful in loss prevention at a point of sale according to embodiments of the present invention include UNIX™, Linux™, Microsoft XP™, AIX™, IBM's i5/OS™, and others as will occur to those of skill in the art. The operating system (154), the POS transaction module (102), the POS security module (122), the POS transaction log (124), the speech to text converter (104), the stored words and phrases indicative or risk of loss (130) in the example of FIG. 1 are all shown disposed in RAM (168), but many components of such modules typically are stored in non-volatile memory also, such as, for example, on a disk drive (170).

The POS server (152) of FIG. 1 includes disk drive adapter (172) coupled through expansion bus (160) and bus adapter (158) to processor (156) and other components of the POS server (152). Disk drive adapter (172) connects non-volatile data storage to the POS server (152) in the form of disk drive (170). Disk drive adapters useful in POS servers for loss prevention at a point of sale according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example POS server (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example POS server (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example POS server (152) of FIG. 1 includes a communications adapter (167) for data communications with other computers (182) and for data communications through a data communications network (101) with other POS equipment in the store. Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for loss prevention at a point of sale according to embodiments of the present invention include modems for wired dial-up communications, Ethernet (IEEE 802.3) adapters for wired data communications network communications, and 802.11 adapters for wireless data communications network communications.

The arrangement of the POS server, network, the manager's terminal, and the equipment at the point of sale in the example of FIG. 1 is for explanation, not for limitation. Loss prevention security systems that carry out loss prevention at a point of sale according to embodiments of the present invention may include additional servers, routers, other devices, and peer-to-peer architectures, not shown in FIG. 1, as will occur to those of skill in the art. This example shows the POS server in the same store with the point of sale, but the POS server could be located more remotely and connected to the point of sale equipment in the store by another network, for example. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

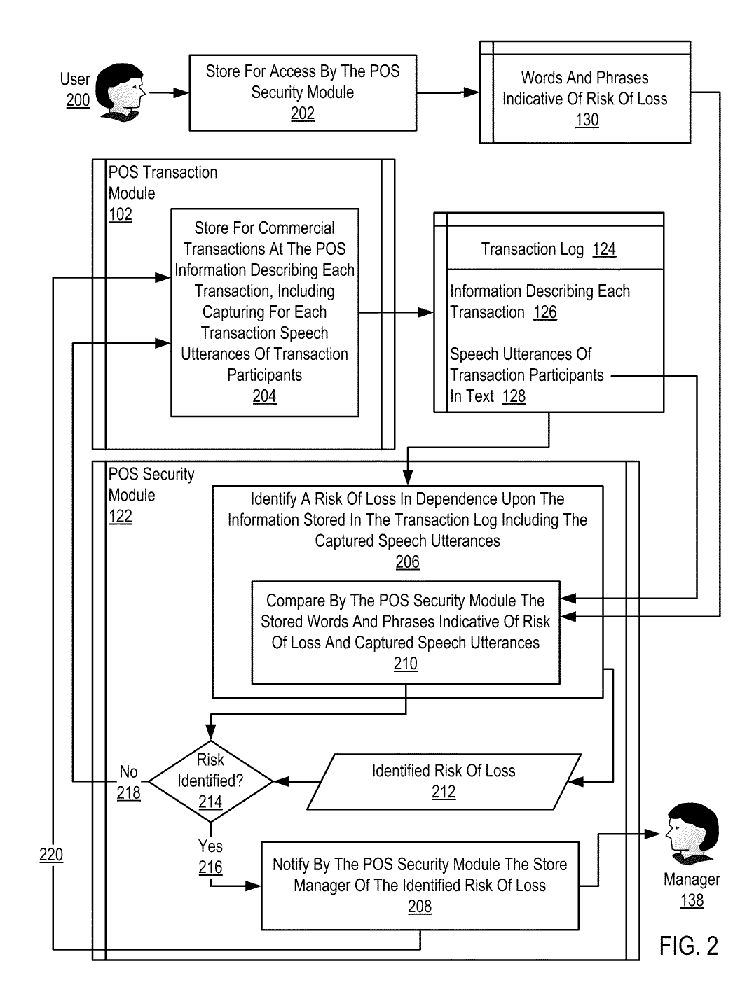

For further explanation, FIG. 2 sets forth a flow chart illustrating an example method of loss prevention at a point of sale according to embodiments of the present invention. The method of FIG. 2 is implemented with apparatus like that illustrated and described above with reference to FIG. 1, apparatus in a store (132) having a store manager (138), apparatus that includes a microphone (136), a speech to text converter (104), a POS transaction module (102), a POS transaction log (124), a POS security module (122), and a voice recorder (134)—so that the method of FIG. 2 is described here with reference to both FIG. 1 as well as FIG. 2.

The method of FIG. 2 includes storing (202) by a user for access by the POS security module (122) words and phrases (130) indicative of risk of loss.

The method of FIG. 2 also includes storing (204), by the POS transaction module (102) in the transaction log (124) for commercial transactions at the POS, information (126) describing each transaction, including capturing for each transaction, into the transaction log through the microphone (136) and the speech to text converter (104) in the form of text, speech utterances (128) of transaction participants. That is, the POS transaction module (102) operates the apparatus of FIG. 1 to capture through the microphone (136) the voice interactions that occur during all transactions (both sales and non-sales) at the POS (100). The POS transaction module can be configured to store all captured voice or to only capture certain words and/or phrases that may be spoken in various languages. The speech to text module may be configured to distinguish the words and/or phrases to capture. In addition, common recurring phrases can be filtered out and not stored in the transaction log. The following phrases could be detected and filtered out from storing in the transaction log: “Did you find everything today?”, or “Do you have a shoppers loyalty card”, and so on. The captured and optionally filtered voice clips are stored in the transaction log in a preferably efficient format. That is, for example, the transaction in the transaction log may point to a location for the voice data instead of embedding all of the voice data directly into the transaction. The result of this mode of operation is that all of the details of the transaction are now stored in addition to the voice data, and the voice data provides a context to the transaction in addition to just the raw data of the transaction. This contextual data for each transaction, particularly across many transactions, becomes useful in later analyzing the transaction information to discover patterns of risk of loss.

The method of FIG. 2 also includes identifying by the POS security module a risk of loss in dependence upon the information stored in the transaction log including the captured speech utterances. Identifying a risk of loss in this example include comparing (210) by the POS security module (122) the stored words and phrases (130) indicative of risk of loss with captured speech utterances (128). Not all comparisons identify a risk of loss, so the method in this example includes a determination (214) whether a risk of loss has been identified. If a particular comparison identifies no risk of loss (218), the processing continues with storing (204) more information describing the transaction including speech and identifying (206) a risk of loss by comparing captured speech (128) with words and phrases (130) indicative or risk of loss. When comparison identifies (216) a risk of loss, the POS security module notifies (208) the store manager (128) of the identified risk of loss (212). In this mode, a loss prevention team, or other user (200), configures the POS security module to check for various words or phrases (130) that may indicate a risk of loss, for example, that a fraudulent transaction is about to take place or is already in progress. This is analogous to many applications that use “screen scraping” to perform a specific function based on text that appears on the screen. But this mode of operation is a new concept of “voice scraping” at the POS in the context of a POS transaction. Note that multiple languages are supported, and can be translated to text, and then compared to the keyword and phrase filters that are configured by the loss prevention department. To summarize this mode, the keyword and phrase indicators, represented here as words and phrases (130) indicative of risk of loss, are configured as filters of the POS security module and if a spoken word or phrase matches at least one of the filters then the POS security module (122) alerts (208) the store manager and optionally of course the POS operator (110), the loss prevention team, and so on, that the occurrence of a POS transaction that will result in fraud or some other loss has been detected.

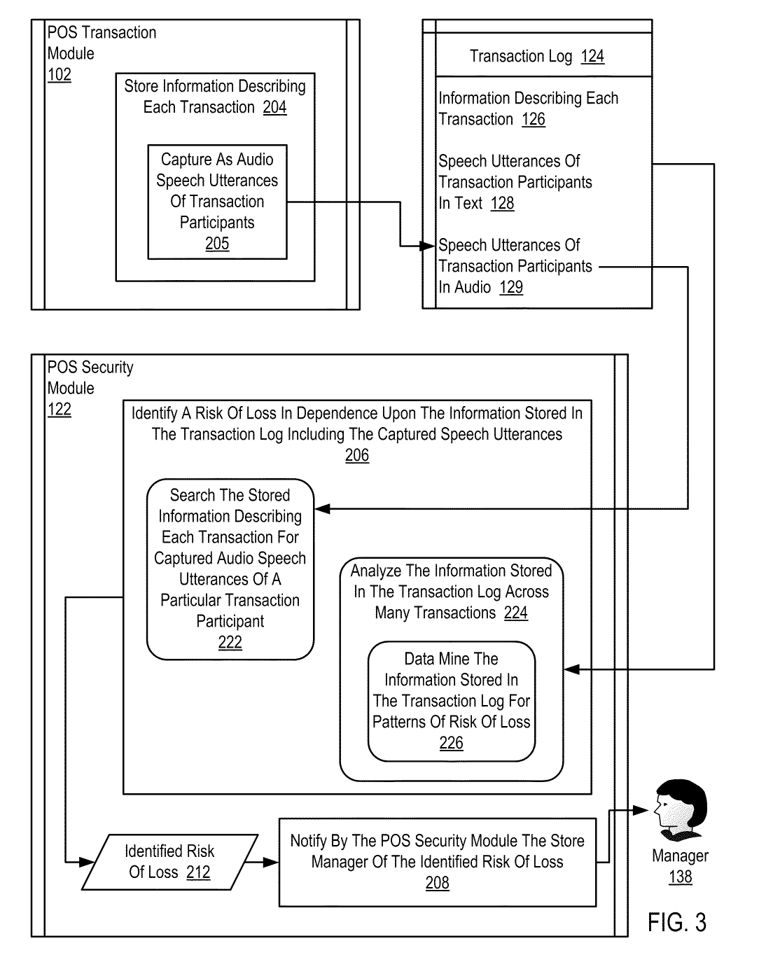

For further explanation, FIG. 3 sets forth a flow chart illustrating a further example method of loss prevention at a point of sale according to embodiments of the present invention. The method of FIG. 3 is similar to the method of FIG. 2, including as it does storing (204) information describing each transaction in a transaction log including speech utterances of transaction participants in the form of text (128), identifying (206) a risk of loss in dependence upon the stored information including the captured speech utterances, and notifying (208) a store manager of the identified risk of loss. The method of FIG. 3, like the method of FIG. 2, is implemented with apparatus like that illustrated and described above with reference to FIG. 1, apparatus in a store (132) having a store manager (138), apparatus that includes a microphone (136), a speech to text converter (104), a POS transaction module (102), a POS transaction log (124), a POS security module (122), and a voice recorder (134)—so that the method of FIG. 3 is described here with reference to both FIG. 1 as well as FIG. 3.

In the method of FIG. 3, storing (204) information describing each transaction includes capturing (205) for each transaction into the transaction log (124) through the microphone (136) and the voice recorder (134) as audio (129), the speech utterances (315) of transaction participants. That is, in the example of FIG. 3, the speech utterances (315) of transaction participants are stored in the form of audio (129) as well as in text form (128). In the example method of FIG. 3, therefore, identifying a risk of loss can be carried out by searching (222) the stored information describing each transaction for captured audio speech utterances of a particular transaction participant. This provides a means for a user to search by words or phrases input via text or voice of the user. Then the POS security module can be configured to display a summary view of all of the transactions that matched the search criteria. From such a summary view, the user can select a transaction from the list for transaction playback for further detailed analysis. The POS security module is configured to play back synchronously both the captured speech utterances (129) for a selected transaction and video captured through the video surveillance camera (106). Synchronous playback is enabled when the information describing each transaction in the transaction log includes a time stamp, particularly a time stamp for each audio clip. In this way, the POS security module provides an enhanced playback of the transaction complete with audio and video in addition to just displaying the playback of the commercial receipt information, transaction type, descriptions of goods, quantities, prices, and so on. The audio transcripts, or voice clips, combined with or superimposed with the loss prevention video, along with the reported sale of the items enhances a loss prevention team's ability to implement loss prevention at a point of sale. The queries for the searches can be quite complex and can combine the search via multiple text queries or transactions types to help determine where loss is occurring in the store. As noted, this configuration includes the ability to search for a given voice signature, for example of a clerk, cashier, manager, or a shopper that is known to be involved in fraudulent transactions. It is also possible in this configuration to correlate the voice from fraudulent shoppers to specific store personnel in an attempt to determine loss patterns.

Also in the method of FIG. 3, identifying a risk of loss can alternatively be carried out by analyzing (224) the information (126, 128, 129) stored in the transaction log across many transactions. In addition, analyzing (226) the information stored in the transaction log across many transactions can include data mining (226) the information (126, 128, 129) stored in the transaction log for patterns of risk of loss. The audio data (129) stored in the transaction log (124) effectively represents a transcript associated with transactions stored in the transaction log. Analysis of the transaction data and the accompanying transcript of the captured voice can establish patterns associated with risk of loss, for example, for the occurrence of fraudulent transactions or outright theft. For example, it may be determined through analysis that certain phrases are always uttered by the customer and responded to by a POS operator when fraudulent checks are cashed at the POS. These detected patterns can be used for training new operators, managers, loss prevention personnel, and so on. These detected patterns can also be configured into the POS to immediately stop, or alert store personnel of a possible pending fraudulent transaction. Also, once patterns are established between the voice and the fraudulent transactions, then a predictive and proactive approach can be taken by creating filters and configuring the POS security module to detect and prevent these types of transactions. This mode may be especially useful in correlating slang or speech accents from different parts of the country to fraudulent transactions.

In view of the explanations set forth above, readers will recognize that the benefits of loss prevention at a point of sale according to embodiments of the present invention include the provision of POS transaction log analysis tools improved to detect patterns of loss, and once learned, the ability to configure a POS loss prevention security system to prevent the occurrence of known patterns of loss, theft, or shrinkage. Exemplary embodiments of the present invention are described largely in the context of fully functional automated apparatus for loss prevention at a point of sale. Readers of skill in the art will recognize, however, that the present invention also may be embodied in a computer program product disposed on recordable media for machine-readable information, including magnetic media, optical media, or other suitable media. Examples of recordable media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of loss prevention at a point of sale (‘POS’), the POS located in a store having a store manager, the method implemented upon POS apparatus that includes a microphone, a speech to text converter, a POS transaction module that is a module of automated computing machinery configured to effect commercial transactions at the POS, a POS transaction log, and a POS security module that is a module of automated computing machinery configured to analyze contents of the POS transaction log to identify risks of loss, the method comprising:
storing, by the POS transaction module in the transaction log for commercial transactions at the POS, information describing each transaction, including capturing for each transaction, into the transaction log through the microphone and the speech to text converter as text, speech utterances of transaction participants;
identifying by the POS security module a risk of loss in dependence upon the information stored in the transaction log including the captured speech utterances; and
notifying by the POS security module the store manager of the identified risk of loss.

2. The method of claim 1 wherein:
the method further comprises storing by a user for access by the POS security module words and phrases indicative of risk of loss; and
identifying a risk of loss further comprises comparing by the POS security module the stored words and phrases indicative of risk of loss with captured speech utterances.

3. The method of claim 1 wherein:
the POS apparatus further comprises a voice recorder;
storing information describing each transaction further comprises capturing for each transaction into the transaction log through the microphone and the voice recorder as audio, the speech utterances of transaction participants;
identifying a risk of loss further comprises searching the stored information describing each transaction for captured audio speech utterances of a particular transaction participant.

4. The method of claim 1 wherein identifying a risk of loss further comprises analyzing the information stored in the transaction log across many transactions.

5. The method of claim 4 wherein analyzing the information stored in the transaction log across many transactions further comprises data mining the information stored in the transaction log for patterns of risk of loss.

6. The method of claim 1 wherein the information describing each transaction further comprises date and time of each transaction, transaction type, descriptions of goods, amounts of goods involved in each transaction, and prices of goods.

7. The method of claim 1 wherein the risks of loss include a risk of loss by fraud and a risk of loss by theft.
Point of sale (‘POS’) apparatus for loss prevention at a POS, the POS located in a store having a store manager, the POS apparatus including a microphone, a speech to text converter, a POS transaction module that is a module of automated computing machinery configured to effect commercial transactions at the POS, a POS transaction log, and a POS security module that is a module of automated computing machinery configured to analyze contents of the POS transaction log to identify risks of loss, the POS apparatus functioning by:
storing, by the POS transaction module in the transaction log for commercial transactions at the POS, information describing each transaction, including capturing for each transaction, into the transaction log through the microphone and the speech to text converter as text, speech utterances of transaction participants;
identifying by the POS security module a risk of loss in dependence upon the information stored in the transaction log including the captured speech utterances; and
notifying by the POS security module the store manager of the identified risk of loss.

8. The POS apparatus of claim 8 wherein:
the POS apparatus further functions by storing for access by the POS security module words and phrases indicative of risk of loss; and
identifying a risk of loss further comprises comparing by the POS security module the stored words and phrases indicative of risk of loss with captured speech utterances.

9. The POS apparatus of claim 8 wherein:
the POS apparatus further comprises a voice recorder;
storing information describing each transaction further comprises capturing for each transaction into the transaction log through the microphone and the voice recorder as audio, the speech utterances of transaction participants; and
identifying a risk of loss further comprises searching the stored information describing each transaction for captured audio speech utterances of a particular transaction participant.

10. The POS apparatus of claim 8 wherein identifying a risk of loss further comprises analyzing the information stored in the transaction log across many transactions.

11. The POS apparatus of claim 11 wherein analyzing the information stored in the transaction log across many transactions further comprises data mining the information stored in the transaction log for patterns of risk of loss.

12. The POS apparatus of claim 8 wherein the information describing each transaction further comprises date and time of each transaction, transaction type, descriptions of goods, amounts of goods involved in each transaction, and prices of goods.

13. The POS apparatus of claim 8 wherein the risks of loss include a risk of loss by fraud and a risk of loss by theft.

14. A computer program product for loss prevention at a point of sale (‘POS’), the POS located in a store having a store manager, the computer program product comprising computer program instructions disposed upon a recordable, computer-readable medium, the computer program instructions operable upon POS apparatus that includes a computer processor, a microphone, a speech to text converter, a POS transaction module that is a module of automated computing machinery configured to effect commercial transactions at the POS, a POS transaction log, and a POS security module that is a module of automated computing machinery configured to analyze contents of the POS transaction log to identify risks of loss, the computer program instructions capable, when executed upon the computer processor, of causing the POS apparatus to function by:
storing, by the POS transaction module in the transaction log for commercial transactions at the POS, information describing each transaction, including capturing for each transaction, into the transaction log through the microphone and the speech to text converter as text, speech utterances of transaction participants;
identifying by the POS security module a risk of loss in dependence upon the information stored in the transaction log including the captured speech utterances; and
notifying by the POS security module the store manager of the identified risk of loss.

15. The computer program product of claim 15 wherein:
the computer program product further comprises computer program instructions capable, when executed on the computer processor, of causing the POS to function by storing for access by the POS security module words and phrases indicative of risk of loss; and
identifying a risk of loss further comprises comparing by the POS security module the stored words and phrases indicative of risk of loss with captured speech utterances.

16. The computer program product of claim 15 wherein:
the POS apparatus further comprises a voice recorder;
storing information describing each transaction further comprises capturing for each transaction into the transaction log through the microphone and the voice recorder as audio, the speech utterances of transaction participants;
identifying a risk of loss further comprises searching the stored information describing each transaction for captured audio speech utterances of a particular transaction participant.

17. The computer program product of claim 15 wherein identifying a risk of loss further comprises analyzing the information stored in the transaction log across many transactions.

18. The computer program product of claim 18 wherein analyzing the information stored in the transaction log across many transactions further comprises data mining the information stored in the transaction log for patterns of risk of loss.

19. The computer program product of claim 15 wherein the information describing each transaction further comprises date and time of each transaction, transaction type, descriptions of goods, amounts of goods involved in each transaction, and prices of goods.
